(19) United States
(12) Patent Application Publication
(10) Pub. No.: US 2005/0137991 A1
(43) Pub. Date: Jun. 23, 2005

(54) Method and system for name and address validation and correction

(76) Inventors: Ben F. Bruce, Arlington, TX (US); Carlos Macia, Plano, TX (US)

Correspondence Address: PHILIP G. MEYERS LAW OFFICE, Suite 302, 1009 Long Prairie Road, Flower Mound, TX, 75022, US

(21) Appl. No.: 11/015,486

(22) Filed: Dec. 18, 2004

Related U.S. Application Data
(60) Provisional application No. 60/530,879, filed on Dec. 18, 2003.

(51) Int. Cl. G06F 17/60

(52) U.S. Cl. 705/410

(57) ABSTRACT

A method of correcting postal name and address information according to the invention includes the step of comparing the name and address information to at least one database of known names and associated addresses to determine if the name and address information matches a known postal recipient. if no match is found, the name and address information is corrected by comparing fields of the name and address information with corresponding fields from the database of known names and addresses, and deducing an incorrect or missing field in the name and address information. An action is then taken using the corrected name and address information, depending on the setting in which the method is used. In most cases, the corrected name and address information will be saved to a computer data storage medium for future use. If a series of name and address records are being read from mail pieces being processed on a postal sorting machine, the final step may comprise sorting a mail piece using the corrected name and address information.

This application claims priority of U.S. Provisional Patent Application Ser. No.: 60/530,879, filed Dec. 18, 2003.

### TECHNICAL FIELD

The present invention relates to the automated validation and correction of information, in particular to mail piece name and address information and lists of name and address information.

### BACKGROUND OF THE INVENTION

Automated mail processing equipment sometimes encounters difficulties while attempting to read all the characters of a recipient or sender's name and address block. Examples of such difficulties are illustrated in FIGS. 1-4. In the example of FIG. 3, the automated mail processing equipment will likely rebuild the city name by deriving it from the state and ZIP code information. However, at the present time, the automated mail processing equipment will not be able to rebuild the house number or the recipient's name, as an example, and therefore the mailpiece will not be sorted to its delivery point code. In the example of FIG. 4, the automated mail processing equipment will be unable to sort the mail piece because is missing all the information from the city, state and ZIP line.

Even when the automated mail processing equipment has successfully read all the characters of a recipient's name and address, as shown in FIG. 2, the address can and should be validated to ensure that all the address elements are correct. Many times, mail pieces contain misspelled street names, mistyped primary or secondary address numbers, erroneous PO Box or rural route numbers, missing street designators (e.g. avenue, lane, drive, etc.), or misspelled recipient's names. Likewise, mailer files containing lists of addresses can also include damaged or inaccurate data, which unless corrected will generate invalid addresses. A need persists for an automated system for correcting addresses without requiring manual intervention, such as video coding by a human operator, or manually updating a mailing list address record or database.

Allen et al. U.S. Pat. No. 5,703,783, the entire contents of which are incorporated herein by reference, describes a system for intercepting and forwarding incorrectly addressed postal mail. According to this method, the postal processing apparatus reads the addressee name and the mailpiece destination address for processing in a database and comparison to a list of names and former addresses in the USPS National Change of Address database of persons who have requested mail forwarding service. If the read name and address match a name and former address in the database, then the mailpiece is identified as having an old address. The apparatus then searches the NCOA database or its equivalent for a forwarding address and delivery point ZIP code corresponding to the address. The forwarding address and delivery point ZIP marking number are printed on the mailpiece in place of the incorrect address, and the mail piece is returned to the mail stream for delivery to the addressee. A forwarding decision such as described in Allen et al. cannot be made successfully if the mailpiece name or address have errors. Thus, the invention enhances the forwarding process by first correcting an incorrect recipient's name or address before determining if the mail piece is to be forwarded.

U.S. Patent Publication 20040065598, Apr. 8, 2004, (Ross et al.) is directed to address disambiguation for mail-piece routing. It proposes the use of name or other non-destination-address information from the mail piece for purposes of disambiguating between two or more possible addresses. The system described by Ross does not cover the disambiguation or correction of addresses contained in a mailing list or database. In addition, it does not address the correction of a recipient's name (individual or business) prior to determining if the mail piece is to be forwarded.

### SUMMARY OF THE INVENTION

The invention contemplates a system wherein recipient's name and addresses are scanned from a mail piece or read from a mailing list or database and pre-processed in such a way that the information is validated, and if necessary, corrected prior to proceeding with the derivation of the mail piece delivery point code or the generation of the destination address. This will help improve the efficiency of both the delivery point code derivation process and the mail forwarding process. Likewise, the system can also be applied to the validation and correction of the information contained in mailer files prior to generating the destination addresses.

A method of correcting postal name and address information according to the invention includes the steps of:

(a) comparing the name and address information to at least one database of known names and associated addresses to determine if the name and address information matches a known postal recipient;

(b) if no match is found, then correcting the name and address information by comparing fields of the name and address information with corresponding fields from the database of known names and addresses, and deducing an incorrect or missing field in the name and address information; and

(c) then taking an action using the corrected name and address information.

The action taken will vary depending on the setting in which the method is used. In most cases, the corrected name and address information will be saved to a computer data storage medium for future use. If steps (a)-(b) are being repeated for successive entries on a mailing list, then step (c) will comprise saving the corrected mailing list in machine-readable form. If steps (a)-(b) are being repeated for name and address information read from mail pieces being processed on a postal sorting machine, step (c) usually comprises sorting a mail piece using the corrected name and address information.

A “list” for purposes of the invention refers to a series of names and addresses in electronic or machine readable form. The list could be a mailing list, or a database intended for another purpose. The series of names and addresses are organized into records, one recipient name and address per record, and within each record, distinct data elements are organized as fields or subfields, as explained further below.

A “field” for purposes of the invention refers to an item of information in an address that is indexed separately in the relevant database. For example, the first and last name of the recipient appearing in the same line of the address will preferably be separate fields in the method of the invention. The deductive process of step (b), in one embodiment, tries to find a match between the compared fields of the name and address information and a single record in the database of known names and addresses. It presumes certain fields of the name and address information are correct, and then attempts to determine the missing or incorrect field by attempting to match the fields it presumes correct with corresponding fields in one or more reference databases of known names and addresses. For example, given a city and a street name but no street number, the system will look for addresses in the database that match both the recipient name and street name. If there is only one that matches, then the street number is presumed to be the number for that address. Similarly, an address table that matches recipient names with their street address, city, state and zip code can be used to determine the city, state and delivery (zip) code in instances where this information is missing or incorrect, such as due to envelope window shifting as described further below. Furthermore, an address table that matches recipient names with their street address, city, state and zip code can be used to correct a misspelled or OCR-misinterpreted recipient's name (individual or business) prior to comparing it with a change of address database. Several different algorithms may be provided to try different combinations of data elements from the read name and address information.

According to a further aspect of the invention, the corrected name and address information may be compared with a change of address database. If the change of address database indicates that a recipient at the corrected address has moved to a new address, appropriate action is taken (e.g., the mailing list is updated, or the mail piece is forwarded to the new address.) The database of known names and associated addresses may then be updated to reflect the new address for the recipient. Indeed, according to an additional feature of the invention, entries from this database may be checked periodically, or otherwise, against corresponding entries in the change of address database in order to keep the database of names and associated addresses current, either as part of the process of updating a mailing list or the like, or as a systematic update to the database of names and associated addresses.

A method of reading a scanned name and address according to the invention includes the steps of:

(a) scanning a mail piece to obtain an image containing name and address information;

(b) decoding name and address data from the image using optical character recognition;

(c) comparing the decoded name and address data to at least one database of known name and associated addresses to determine if the decoded name and address data matches a known name and address combination;

(d) if no match is found, then correcting the name or address data by comparing fields of the name and address data with corresponding fields of known name and associated addresses from the database, and deducing an incorrect or missing field in the name or address data; and

(e) then further processing the mail piece using the corrected name and address data. As noted above, a step of checking the corrected name and address to see if the recipient has moved may be part of this method.

Dividing up name and address data into useful parts or subfields can aid this process. For example, the example described in the foregoing publication of Ross et al. describes only the simple case where the address has shifted downwardly relative to a transparent window in the envelope such that only the name and street address are visible. By dividing each address line up further into subfields such as street number, street name first word, street name second word and so on, it becomes possible to deal more easily with other types of errors, such as shifting of the address left or right in the address window, or simple misspellings of individual words. Thus, according to improved form of the foregoing method, step (d) is carried out using subfields or portions of an address line in the deductive process, especially when portions of two or more lines in the recipient address are missing from the scanned image. The deductive process can still be carried out using portions of the first, second and third lines, provided that the name and address database is indexed (split into subfields) in the same fashion.

In some cases, a mailing list for correction supplied by a mailer will not be divided into machine readable address fields. Conventional address interpretation software can be used to interpret the mailing list entries in order to generate a list of names and addresses for processing. A method of reading a name and address from a mailer list according to this aspect of the invention includes the steps of:

(a) reading a record from a list, or database, containing address information;

(b) decoding name and address data from the record using address interpretation software;

(c) comparing the decoded name and address data to at least one database of known names and associated addresses to determine if the decoded name and address data matches a known name and address combination;

(d) if no match is found, then correcting the name or address data by comparing fields of the name and address data with corresponding fields of known name and associated addresses from the database, and deducing an incorrect or missing field in the name or address data; and

(e) then further processing the address record using the corrected name and address data, i.e., saving it to a data storage medium, transmitting it to a customer in data form, or creating a mailing using the corrected list to address the mail pieces. As noted above, a step of checking the corrected name and address to see if the recipient has moved may be part of this method.

The present invention further contemplates corresponding systems for carrying out the foregoing methods. For processing of mailing lists, only a computer, a database of known addresses (preferably one which matches individual recipient names with their associated addresses), appropriate program logic (software) and input/output devices are needed. For postal sorting, the system would include a postal processing machine having OCR capability, a database of known addresses, preferably one which matches individual recipient names with their associated addresses, and corresponding program logic operable on a computer for carrying out the steps of the correction process. These and other aspects of the invention are explained further in the examples below.

### BRIEF DESCRIPTION OF THE DRAWING

In the accompanying drawing:

FIG. 1 is a front view of a typical mail envelope with an address window;

FIG. 2 is the address window of FIG. 1 under normal conditions;

FIG. 3 is the address window of FIG. 1 where the insert has shifted slightly to the left; and

FIG. 4 is the address window of FIG. 1 where the insert has shifted slightly to the bottom.

### DETAILED DESCRIPTION

A typical process according to the invention takes the name and address information scanned from a mail piece or read from a mailing list or database, and preferably attempts to validate it by using several types of databases. Such a process can use the USPS City/State database, the USPS ZIP+4 database, the USPS Delivery Point File (DPF) database, and a national database that contains a very large number of names and associated addresses of individuals and businesses. Traditional methods correlate the data by limiting the search first by the city and state or ZIP Code information, and then, for example, by the street number and street name plus the street designator (e.g. avenue, street, parkway, etc.) to determine if the address is valid. These traditional methods do not utilize the recipient's name (individual, family or business) to aid in the correlation process. Printed characters and numerals damaged in the printing process or incorrectly entered into a mailer's database, or lacking the proper street designator, for instance, may result in data that fails to correlate.

By correlating the information present in one or more of the databases listed above and by processing the information in a non-traditional manner, such as first using the street name without regard to the city name, or using the name of an individual or business along with the street name without regard to the city, the process of the invention attempts to correct the invalid name or address scanned from a mail piece or read from a mailer's list. This process will often uniquely resolve domestic United States addresses without requiring complete city, state, ZIP Code, or street information. In general, if the process determines that a particular name or address element is incorrect or missing and enough information is available to accurately remedy the problem, the name or address is then corrected.

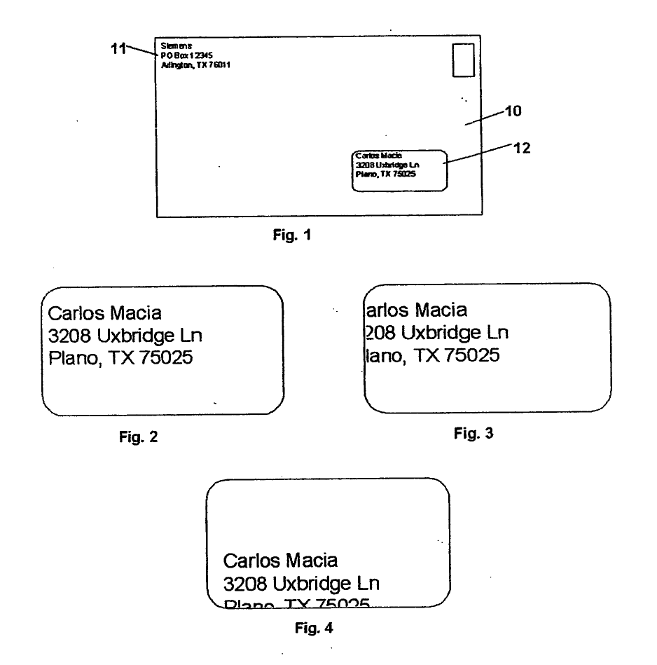

The examples of FIGS. 1-3 will be used to better illustrate the process described above. A mailpiece as shown in FIG. 1 has an envelope 10 with a return address 11 in the upper left corner and a recipient address on an insert that is visible through a window 12. When the insert inside envelope 10, as shown in FIG. 3, shifts to the left, the recipient's name is partially obscured beneath the edge of window 12. The name becomes ARLOS MACIA, the street address becomes 208 UXBRIDGE LN, and the city becomes LANO, Tex. 75025. By searching the city/state database, the process determines that the city is indeed PLANO, Tex. 75025. If the zip code is known, by OCR or by scanning of a bar code, which may be on the envelope, the city name need not be determined for delivery purposes, but may be desired in order to provide or print a complete corrected address. For this purpose, the system can if necessary compare the letters LANO with the names of communities in that delivery code zone and readily determine that PLANO is the only partial match.

Next, by looking up the last name, MACIA, along with the street, UXBRIDGE LN, in the city of PLANO, using the national database of names and associated addresses, the process is able to rebuild the recipient's name, CARLOS MACIA, and the street address, 3208 UXBRIDGE LN, if there is only one recipient with the last name MACIA on that street. Finally, the ZIP+4 and DPF databases are used to validate that indeed the corrected address, 3208 UXBRIDGE LN, PLANO, Tex. 75025, is a valid delivery point code.

If more than one recipient with the last name MACIA is found on that street, as would often be the case where different family members receive mail at the same street address or where relatives live near one another, the process can go further and determine the individual recipient by comparing the first names of recipients with the last name MACIA on that street with the partial first name ARLOS from the scanned address. If the text string ARLOS is found in only one of the names, then that name (CARLOS) is presumed to be the correct one. Techniques such as trigram hashing can be used for this purpose. Using trigram hashing, each word of a searchable subfield, in this case the first name subfield, is used to create a series of overlapping, consecutive 3 letter trigrams that appear in the field: CAR, ARL, RLO, LOS. The fragment ARLOS yields three trigrams in common with CARLOS, and on this basis the system concludes that the correct name is CARLOS.

In FIG. 4, the insert inside the envelope has shifted to the bottom. The recipient's city, state and ZIP are partially covered and therefore are not properly read by the automated mail processing equipment. In this case, the process is able to rebuild the missing information by looking up the name, CARLOS MACIA, and the street address, 3208 UXBRIDGE LN, in the national database of names and addresses and finding only a single match.

Truncation errors of the kind shown in FIGS. 3 and 4 are common, and routines used by the computer system attempting to correct the error can be designed to attempt to handle each possibility, i.e. shifted left, shifted right, shifted to top (obscuring name) or shifted to bottom. In the example above, the system in the shifted left case assumes the information on the right end of each address line is correct. If the information were shifted to the right, the opposite would be true, and it might be necessary to deduce the zip code based on the city and state.

The system of the invention will also correct other types of errors, such as simple misspellings of recipient's name or address. In some cases, the system may try all possible combinations of scanned name and address fields and still be unable to resolve a unique address, in which case the original name and address will remain unmodified.

Once the process has validated and, if necessary, corrected a name or address, a mail forwarding process can be invoked to determine if the address needs to be forwarded or not. The validation and correction process described above can also significantly improve the efficiency of the mail forwarding process as described in Allen et al. In the case of FIG. 3, if the recipient had moved, a mail piece with the name read as ARLOS MACIA would not have been forwarded. However, once the address is corrected and the name rebuilt as CARLOS MACIA, the mail piece can be properly forwarded. If a mailing list is being updated, the new address to which mail should be forwarded is substituted for the one on the mailing list.

The process of Allen et al. ideally is carried out on a real time basis during sorting. If a mail piece needs to be forwarded, it is most desirable to determine this while the mailpiece is still being conveyed by the sorting machine, between the time it is imaged by an OCR reader and the time it reaches the first divert gate of the sorting system. According to the present invention, when used in conjunction with a process as described in Allen et al., the address correction is first attempted and if successful, then a check to see if the mail piece should be forwarded is made. On some sorting machines, such as DIOSS machines, with a relatively long conveyor path between the OCR reader and the first divert gate, it will be possible to perform both processes before the mailpiece reaches the divert gate, so that it can be diverted as a piece in need of forwarding rather than as a reject in need of video coding. On other machines, to allow sufficient time for processing, a mailpiece in need of address correction and possible forwarding has an ID tag applied to it and is sorted as a reject, to be introduced into the mail stream later when the processing has been completed. Implementation of the process of the invention as part of the Allen et al. process, also known as PARS, increases the chances of arriving at the correct delivery point, a must for PARS processing. By correcting the name of the recipient, the process increases the chances of matching the name on the address with the person who filed the move request with the USPS.

The process of the invention can be used for the review and correction of mailing lists in a manner similar to that described in commonly-assigned Sipe et al. U.S. Ser. No. 10/290,029, filed Nov. 7, 2002 (“Sipe et al.”), the entire contents of which are hereby incorporated by reference herein. Sipe et al. describe a process that takes daily address information and uses it to update the United States Postal Service (USPS) NCOA database, creating a new database that is current daily. The new database is intended to assist businesses in making corrections to address information prior to printing address labels and delivering the items to a mail or parcel service provider. The Sipe et al. process enables the collection of address change information at near real time, validation of the change information, and distribution of the updated database to licensed users on a daily or more frequent basis. In one embodiment of the Sipe et al. process, a mailing list is sent to the database provider in electronic form, is checked for changes of address, and then the corrected mailing list is returned to the customer in electronic form, such as by email. The same procedure can be used with the process of the invention.

A database such as that described in Sipe et al. is suitable for use as the change of address database in the present invention, in any context where the corrected addresses need to be checked to see if the recipient has moved. Further, if the change of address database is more current than the database of names and associated addresses used in the method of the invention, it is appropriate to update the database of names and associated addresses whenever a corrected address determined according to the invention proves to be an old or former address of the named recipient.

In summary, the automatic name and address validation and correction process of the invention provides various means to perform address and name hygiene prior to making the final sort decision in an automated mail processing system, or prior to generating a delivery address from the information in a mailer's list or database. This system will minimize delivery errors, will increase the efficiency of fully automated mail sequencing systems, and will improve the quality of mailer address list files. There are at least two fields of application of the invention, the first being the validation and potential correction of addresses (name and address) scanned from a mail piece. This is preferably attempted in real-time while the mailpiece is being sorted by the automated mail processing equipment, but it can also be carried out during the off-line video coding phase. The second is the validation and potential correction of addresses (name and address) read from a mailer's list, or database. This can be done (a) in non-real time or batched mode, whereby a file containing a list of addresses is validated and corrected where necessary, or (b) in real-time, before the address label is printed and affixed to the mail piece during the creation of the mail piece.

In the context of mail sorting, it is possible to perform the method of the invention in an off-line mode, but without human intervention by a video-coding operator. If the correction and forwarding check process fails to complete by the time the mail piece reaches the first sorting gate, the mail piece can be labeled with an ID tag and sorted to a special bin for reprocessing. The results of the process are then linked to the ID number of the tag and saved. When the tagged mail piece is fed though an input/output subsystem, a POSTNET barcode bearing the corrected address is applied, or in the case of mail forwarding, a label is applied bearing the corrected or forwarding address.

Although several embodiments of the present invention have been described in the foregoing detailed description and illustrated in the accompanying drawings, it will be understood by those skilled in the art that the invention is not limited to the embodiments disclosed but is capable of numerous rearrangements, substitutions and modifications without departing from the spirit of the invention as expressed in the appended claims. For example, the word “table” is used in the broadest sense to include any type of virtual table storable in computer memory where a series of data elements is related to another series of data elements, as in the manner of rows and columns. Similarly, “fields” used in the method of the invention may be temporary ones created by the software implementing the method, as opposed to permanent ones embodied in the layout of the database of names and addresses.

1. A computer-implemented method of correcting a list of postal name and address information for a plurality of postal recipients, comprising the steps of:
(a) comparing the name and address information for a recipient to at least one database of known names and associated addresses to determine if the name and address information matches a known postal recipient;
(b) if no match is found, then correcting the name and address information by comparing fields of the name and address information with corresponding fields from the database of known names and addresses, and deducing an incorrect or missing field in the name and address information; and
(c) repeating steps (a) and (b) for additional entries on the list; and
(d) then taking an action using the corrected name and address information.

2. The method of claim 1, wherein step (d) comprises saving the corrected name and address information to a computer data storage medium in machine readable form.

3. The method of claim 1, wherein steps (a)-(c) are carried out just prior to creating a mailing to recipients on the list, and step (d) comprises printing the corrected name and address information on the created mailing.

4. The method of claim 1, wherein the list of postal name and address information was received from a customer, and step (d) comprises transmitting data containing the corrected name and address information back to the customer.

5. The method of claim 1, further comprising:
comparing the corrected name and address information with a change of address database;
if the change of address database indicates that a recipient at the corrected name and address has moved to a new address, then updating the database of known names and addresses to reflect the new address for the recipient and changing the list to include the new address for the recipient.

6. A computer-implemented method of mail processing, comprising:
(a) scanning a mail piece to obtain an image containing name and address information;
(b) decoding name and address data from the image using optical character recognition;
(c) comparing the decoded name and address data to at least one database of known name and associated addresses to determine if the decoded name and address data matches a known name and address combination;
(d) if no match is found, then correcting the name or address data by comparing fields of the name and address data with corresponding fields of known name and associated addresses from the database, and deducing an incorrect or missing field in the name or address data, wherein the name and address data are limited to a portion of a recipient name and a portion of a recipient address; and
(e) then further processing the mail piece using the corrected name and address data.

7. The method of claim 6, wherein the decoded name and address data represents a left or right truncated form of the corrected name and address data.

8. The method of claim 6, wherein step (e) further comprises applying the corrected name and address data to the mail piece.

9. The method of claim 6, wherein step (e) further comprises sorting the mail piece using the corrected name and address data.

10. The method of claim 8, wherein step (e) further comprises sorting the mail piece using the corrected name and address data.

11. The method of claim 6, wherein step (d) further comprises determining if a character string representing a name or address line matches a truncated form of a name or address line of a known name and associated address in the database.

12. A computer-implemented method of forwarding a mail piece, including the steps of:
(a) scanning a mail piece to obtain an image containing name and address information;
(b) decoding recipient name and address data from the image using optical character recognition;
(c) comparing the decoded name and address data to at least one database of known recipient names and associated addresses to determine if the decoded name and address data matches a known name and address;
(d) if no match is found, then correcting the name and address data by comparing fields of the name and address data with corresponding fields of known names and addresses from the database, and deducing an incorrect or missing field in the name or address data;
(e) comparing the corrected name and address data to a list of incorrect delivery destinations;
(f) determining a forwarding delivery destination for the mail piece which corresponds to the incorrect delivery destination on the list;
(g) correcting a delivery destination marking on the mail piece to indicate the forwarding delivery destination; and
(h) forwarding the mail piece to the forwarding delivery destination.

13. The method of claim 12, wherein the incorrect or missing field comprises a misspelled recipient name.
